(19) United States
(12) Patent Application Publication
(10) Pub. No.: US 2018/0189045 A1
(43) Pub. Date: Jul. 5, 2018

(54) Motor Vehicle Control Unit With Power Saving Mode For A Parking Phase

(71) Applicant: AUDI AG, Ingolstadt (DE)

(72) Inventors: Christoph DALKE, Kipfenberg (DE); Christian GRUBER, Ingolstadt (DE); Michael SCHMAILZL,, Kösching (DE); Matthijs PAFFEN, Ingolstadt (DE)

(73) Assignee: AUDI AG, Ingolstadt (DE)

(21) Appl. No.: 15/316,665

(22) PCT Filed: Apr. 17, 2015
(86) PCT No.: PCT/EP2015/000810

§ 371 Date: Dec. 6, 2016

(51) Int. Cl. G06F 8/65; G06F 1/26; B60W 50/04; B60W 30/06

(52) U.S. Cl. CPC G06F 8/65; G06F 1/26; B60W 2050/046; B60W 30/06; B60W 50/045

(57) ABSTRACT

The invention relates to a method for operating a control device of a motor vehicle during a park phase, wherein in the method a transmitted ignition-off signal for initiating the park phase is received in the motor vehicle by the control unit and at least one electronic component of the control unit is switched off. The object of the invention is to carry out an update of the operating software of a control unit without an interruption of the operation of the control unit that is disruptive for the user of the motor vehicle. After receiving the ignition-off signal, a processor core and a memory storage unit in the control unit, in which the operating software is stored, continue to operate. The update is then carried out during the park phase by the processor core on the basis of update data.

### TECHNICAL FIELD

The invention relates to a motor vehicle having at least one control unit, in which one or more electrical components are switched off during the parking phase of the motor vehicle to reduce energy consumption. A method for operating a motor vehicle control unit so that at least one electronic component in the control unit is switched off as a function of an ignition-off signal is also a part of the invention.

### BACKGROUND

A control unit for a motor vehicle can be designed as programmable, where operating software is stored in a memory storage unit of the control unit and the operating software is executed by a processing device of the control unit and functionalities of the control unit are hereby provided in the motor vehicle. Should the operating software turn out to be obsolete or erroneous, an update of the operating software is thus required in which the operating software is at least partially replaced by update data. An effort is made to allow the user of the motor vehicle to perform the update himself, so that he need not take the motor vehicle to a repair shop to receive support from the service personnel.

It is known from US 2008/0108335 A1 that service data for a control unit update can be transmitted via an internet connection from a maintenance operation for the motor vehicle to the control unit of the motor vehicle.

During the update, the control unit typically cannot be used in the intended manner in normal operation since the operating software is being changed and the processing device, therefore, cannot access the operating software. An update thus represents an undesired interruption in the normal operation of the control unit.

A method for installing a software module in the control unit of a motor vehicle is known from DE 10 2007 040 093 A1, wherein the software module is installed in the control unit if installation requirements regarding at least some of the operating state parameters of the motor vehicle as specified in the software module are fulfilled. For example, an ignition of the motor vehicle can be tested as an operating condition of this sort.

An update to a parked motor vehicle is possible. The operation of the control unit when the ignition is switched off is, however, generally undesirable, since to do this, the control unit uses electrical energy which must be provided by a battery in the motor vehicle, which brings the danger that the motor vehicle will not then be able to start because of an overly discharged battery.

The provision of a control unit to be programmed with data during an after-run cycle phase via a data link networked with other control units, wherein the additional control units are disconnected from the data link is known from DE 100 07 610 A1. Limiting the after-run cycle time prevents the control unit from too-deeply discharging the motor vehicle battery.

The disadvantage to this is that a comprehensive update, in which much time is required to process the update data, cannot be carried out within the time of the after-run cycle.

### BRIEF DESCRIPTION OF THE DRAWINGS/FIGURES

FIG. 1 illustrates a schematic representation of an embodiment of the motor vehicle according to the invention.

FIG. 2 illustrates a diagram with a schematized profile for power consumption by a control unit of the motor vehicle from FIG. 1.

### DETAILED DESCRIPTION

The object of the invention is to carry out an update of the operating software of a control unit without an interruption of the control unit's operation that is disruptive for the user of the motor vehicle.

The object is achieved by the objects of the independent claims. Advantageous refinements of the invention arise from the features of the dependent claims.

The invention provides a method which uses the park phase of a motor vehicle to perform an update in a control unit. If the user of the vehicle stops the motor and then leaves the car, the controller remains active in a low-power mode for a longer period of time to carry out the update. The method according to the invention provides that devices in the motor vehicle are switched off during the parking phase in which the ignition of the motor vehicle is switched off. At least one electronic component of the control unit which is not required for the update is also actually turned off. The switching off occurs as a function of an ignition-off signal which is sent out in the motor vehicle to the control unit to initiate the parking phase, for example, via a communication bus in the motor vehicle. The control unit thus receives the ignition-off signal and subsequently switches off at least one electronic component. This reduces the energy consumption of the control unit as compared to a mode when the ignition is switched on. The reduction of energy consumption is preferably at least 50 percent, in particular 70 percent.

According to the invention, however, the control unit is not completely switched off. Instead, after receiving the ignition-off signal, a processor core and a storage facility operate in the control unit. The memory storage unit is the unit in which the operating software of the control unit is stored for operation while the ignition is switched on, thus the operating software for normal operation. During the park phase, an update of the operating software is now accomplished through the processor core based on update data.

Insofar as only a small part of the control unit remains “awake,” the control unit can remain in operation for a longer period of time to carry out the updates without the total energy usage being thereby greater than in a control unit that continues operating completely, meaning with all its electronic components, while the update is being carried out. An update can therefore be carried out on the basis of more comprehensive data than is possible in the prior art.

The ignition-off signal can, for example, be a digital signal which represents a terminal 15 signal, as is defined in the German Industrial Standard DIN 72552. In the park phase, a drive motor is accordingly switched off by switching off the ignition of the motor vehicle, for example an internal combustion engine or electric motor, and the described control unit runs exclusively with electrical energy from a motor vehicle battery of the motor vehicle.

A further embodiment of the method according to the invention concerns a variation of the control unit according to the invention in which the control unit is subdivided into a first and at least a second power domain, wherein each power domain represents an electronic circuit of the control unit, which is connected by its own electrical power supply line with an electrical supply connection to the control unit. The supply connection is a connection to the vehicle electrical system by which the supply voltage is received from the motor vehicle battery. In order to now be able to specifically reduce the energy usage of the control unit and still be able to carry out the update, the processor cores and the memory storage unit, on the one hand, and at least one electronic component not necessary for the update, on the other, are located on different power domains. Upon receiving the ignition-off signal, at least one of the power domains is electronically disconnected from the supply connection. With this, the electronic components located in that power domain are then switched off. The at least one power domain with the processor core and the memory storage unit remains supplied with voltage.

In order to be able to carry out a finer division between electronic components which run during the park phase and those which are switched off, but not incur undesirably large circuit complexity, a further embodiment of the method provides that the processor core and a memory controller of the memory storage unit are supplied via an integrated switching circuit with a variable clock rate and/or peripherals designed to be separately switched off. This is realizable, for example, via a so-called system-on-a-chip (SoC). A switchable peripheral can include, for example, a GPU (Graphical Processing Unit), interfaces for transferring data, for example a USB interface (USB—Universal Serial Bus), a UART interface (UART—Universal Asynchronous Receiver Transmitter) and/or an HDMI interface (HDMI—High Definition Multimedia Interface). According to the further embodiment of the method, the integrated circuit as a function of the ignition-off signal reduces the clock rate and/or switches off the peripherals not needed for the update. The circuit can, for example, have several power modes which are differentiated from each other by different clock rates. An integrated circuit can also be provided which has a configuration register, through whose contents it is determined which peripheral components are switched off.

The energy or power consumption of the control unit during the park phase also depends on how difficult it is to obtain the update data. An embodiment of the method provides that a part of the update data can be received with the ignition on before the park phase via a wireless connection, an internet connection for example, from outside the motor vehicle or from a portable device connected to the control unit, for example a smartphone, and the received update data then temporarily stored in the memory storage unit. This results in the advantage that, when the ignition is switched on, electrical energy from a generator of the motor vehicle, for example, is available, and the acquisition and storage of the update data then does not lead to an undesired discharge of the vehicle battery.

Another embodiment of the method provides that at least a part of the update data is read out of a memory storage unit connected to the control unit during the park phase, for example from a SD card (SD—Secure Digital Memory Card) or a CD-ROM. Reading from a memory storage unit has the advantage that no wireless module such as, for example, a mobile wireless module for GSM, UMTS or LTE (GSM—Global System for Mobile Communications, UMTS—Universal Mobile Telecommunications System, LTE—Long Term Evolution) or a network module, such as for example a WLAN module (WLAN—Wireless Local Area Network) that has a greater energy requirement must be used as a reading device for a portable memory storage unit.

Another embodiment of the method provides that at least a part of the update data is received during the park phase from the internet via a mobile wireless connection and/or a WLAN connection. The advantage arises from the update data being available independent of user behavior. The user cannot then accidentally forget to insert the described portable memory storage unit into the read-out means for the memory storage unit, for example.

In order to protect the motor vehicle battery from total discharge, for example in the case of an error during the update which can result in a long operation of the control unit, a further embodiment of the method provides that, using a timer value stored in the control unit, a predetermined maximum time span for the update can be specified and an abort signal to end the update can be created by a timer in the control device as a function of the timer value. This ensures that, independently of the progress of the update, the control unit will only run up to the expiration of the time period predetermined by the timer value.

To end the update, a power controller of the control unit (this means a power control unit or power supply) is preferably activated and switched off by the power controller of the processor core and the memory storage unit. Then the power controller can also turn itself off. Then the control unit is switched off and uses no electrical energy to run the processor core and the memory storage unit.

In an advantageous manner, the user of the motor vehicle is given the possibility to control the energy usage of the memory storage unit in that he decides whether an update should even be conducted at all. In this embodiment, the processor core and the memory storage unit are only operated during the park phase if, before the park phase while the ignition is on, the user of the motor vehicle has given an update command on a control panel of the motor vehicle, for example an infotainment system of the motor vehicle. Otherwise, the control device is completely switched off upon reception of the ignition-off signal.

As explained above, a control unit for a motor vehicle which has a receiving device for receiving an ignition-off signal, for example a bus connector for a communication bus of the motor vehicle, also belongs to the invention. In addition, a supply connection for receiving a supply voltage from the vehicle's battery and electronics having at least one processor core and a memory storage unit, in which the operating software for the at least one processor core is stored, are provided. The control device according to the invention is thus designed to carry out an embodiment of the method according to the invention.

The control device in this context is preferably designed as an infotainment system for a motor vehicle. The control device can also, however, be configured as an instrument cluster or as a control unit to control an actuator or a sensor of the motor vehicle.

Finally, a motor vehicle which is characterized in that it has at least one control unit which represents an embodiment of the control unit according to the invention is also part of the invention.

In the following, an exemplary embodiment of the invention is described. This shows:

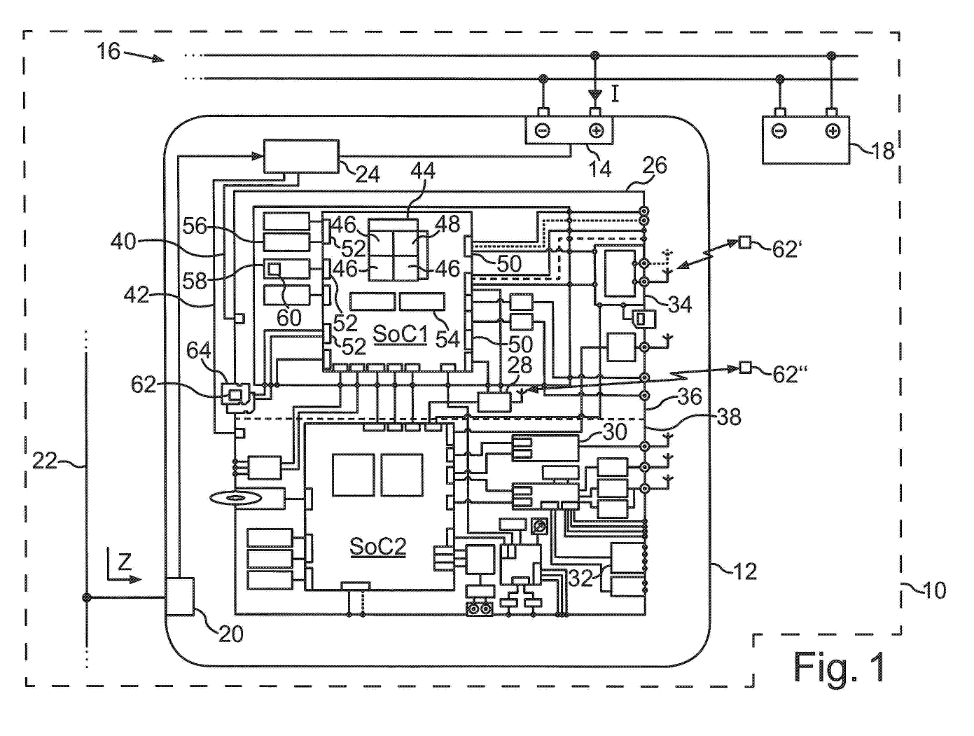

FIG. 1 a schematic representation of an embodiment of the motor vehicle according to the invention and

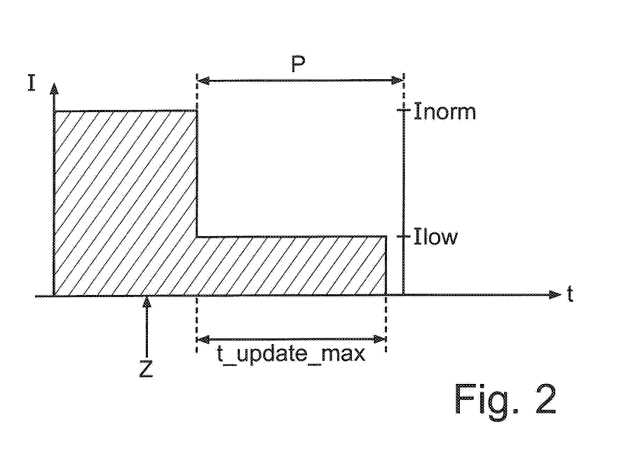

FIG. 2 a diagram with a schematized profile for power consumption by a control unit of the motor vehicle from FIG. 1.

The exemplary embodiment described below is a preferred embodiment of the invention. In the exemplary embodiment, however, the described embodiment components each represent single features to be considered independently from each other, which the invention also further develops independently and which are also to be considered individually or in another of the described combinations as a component of the invention. Additionally, the described embodiment is also expandable through additional features of the invention already described.

FIG. 1 shows a motor vehicle, which could be a motor car, such as a passenger car, for example. Motor vehicle 10 can have a control unit 12, which can, for example, be a component of an infotainment system of motor vehicle 10 or an instrument cluster of motor vehicle 10. Control unit 12 can have a supply connection 14, via which control unit 12 can be connected to the vehicle electrical system 16 for the supply of control unit 12 with electrical energy. Vehicle electrical system 16 can, for example, be supplied from a vehicle battery 18, which means supply connection 14 can be electrically connected to vehicle battery 18 via the vehicle electrical system 16. Control unit 12 can further be connected via a bus coupler or bus connector 20 to a communication bus 22, for example a CAN-Bus (CAN—Controller Area Network).

In motor vehicle 10, it can be provided that control unit 12 receives an ignition-off signal Z via communication bus 22 at the beginning of a park phase if the user switches off motor vehicle 10, which means turns off the drive motor, and removes an ignition key from the ignition switch, for example, by which control unit 12 is signaled that it must change to an energy-saving mode so that motor vehicle battery 18 is not unnecessarily discharged during the park phase.

Control device 12 can have, for example, a power controller 24 to control its energy usage which can be a power supply with its own control circuit or a different circuit logic to control and divide the energy flow from supply connection 14 to device electronics 26. Device electronics 26 can be, for example a circuit board on which can be arranged electronic components needed to operate control unit 12.

In the example shown, device electronics 26 include a first system SoC1 (SoC—system-on-a-chip) as well as a system SoC2. Device electronics 26 can additionally have separate switching modules, such as a WLAN receiver 28, a DAB receiver (DAB—Digital Audio Broadcasting) 30, an audio amplifier 32 and a mobile wireless module 34, for example for LTE or UTMS. The above circuits are only exemplary.

Device electronics 26 can, for example, be divided into two power domains 36, 38, which can each be connected via a dedicated supply line 40, 42 to power controller 24. Power controller 24 can interrupt an electrical connection between connecting lines 40, 42 and supply connection 14 as a function of the ignition-off signal Z, for example by switching a semiconductor switch or a relay. In the example shown, it can be provided that supply line 42 for power domain 38 is switched current-free so that, for example, system SoC2, DAB receiver 30 and audio amplifier 32 are switched off and thus consume no additional electrical energy.

In motor vehicle 10, however, it is provided that system SoC 1 continues partly operating so that a system of control unit 12 updates during the park phase, which means to carry out an update.

It can thereby be provided that parts within power domain 36 which are not needed for the update or the power domain as a whole can be switched off. In the example shown, system SoC1 includes a processor 44 with, for example, four processor cores, 46, 48. It can be provided that, of the four processor cores 46, 48, processor core 46 can be shut down or deactivated and only the single processor core 48 used. In addition, system SoC1 can also have peripheral components 50, 52 and a GPU (Graphical Processing Unit) 54. During the park phase, no graphic data needs to be displayed, so that GPU 54 can also be deactivated. Peripheral components 50 can, for example, be an HDMI controller (HDMI—High Definition Multi Media Interface) and a USB controller (USB—Universal Serial Bus). Peripheral components 52 can be, for example, an SDIO controller (SDIO memory controller for SD cards), a memory controller for RAM chips 56 and a memory controller for flash memory chips 58 for non-volatile data storage. In the illustrated example, operating software 60 for control unit 12 which is used to operate control unit 12 during normal operation, which means when motor vehicle 10 is switched on, is stored in flash memory chip 58. Operating software 60 is updated with an update during the park phase using peripheral 52, i.e. using processor core 48, RAM chips 56 and the memory controller.

It can be provided for this, for example, that update data 62 can be read from an SD card 64 using peripheral 52 and transferred via processor core 48 into flash memory 58. It can also be provided that update data 62′ be received via a mobile wireless module 34, for example, from a mobile wireless network (not shown). It can also be provided that update data 62″ be received using a WLAN wireless module 28.

Since processor core 48, peripheral components 52, RAM chip 56 and flash memory 58 in control unit 12 are only operated during the park phase, control unit 12 needs relatively little electrical energy, despite the update operation.

The energy reduction is illustrated in FIG. 2 using the consumption of control unit 12 as it can be measured at supply connection 14, for example. In normal operation, for example, an amount of energy Inorm can flow to supply connection 14. Upon receiving ignition-off signal Z, power domain 38 in the example is switched off via power controller 24 and peripheral components 50 and GPU 54, for example, are switched off via system SoC 1. In this way, the power consumption is reduced to a level of Ilow. So that motor vehicle battery 18 is protected over time t even under low energy usage with the current Ilow and the ability of motor vehicle 10 to restart is not endangered, within park phase P, the operation of control unit 12 for the update operation is limited to a time t_update_max, in that this variable value, which can be within a range of 10 minutes to 90 minutes for example, is recorded in a timer (not shown) in control unit 12, which monitors the time elapsed and at the end of maximum update time, t_update_max for example, signals power controller 24, for example, to also switch off power domain 36, which means to interrupt the electrical connection between supply line 40 and supply connection 14. Afterwards, power controller 24 can then conduct an auto-shutoff. In this manner, the electricity is then reduced preferably to 0 amp, but less than Ilow, at least.

Upon starting motor vehicle 10, which can also be communicated with control unit 12 via an ignition-on signal via communication bus 22, for example, system SoC1 in control unit 12 is put into service, which then loads operating software 60 from flash chip 58, which is then the updated operating software using update data 62, 62′, 62″.

If the user of motor vehicle 10 then stops the motor and leaves motor vehicle 10, control device 12, the infotainment control unit, for example, remains active in low-power mode in order to load an update for a longer time. The update time is reduced for the user by this since he is not conscious of the update during park phase P. A larger battery is also not needed for this even though a longer after-run cycle occurs, that is, the operational time of control unit 12 after switching the motor off. Using the described methods, the after-run cycle can be increased by a factor of six without the energy consumption of control unit 12 being larger as a result than would be the case if control unit 12 were fully operational during the park phase in order to carry out the update.

The user can start the update, for example, while control unit 12 is switched on, that is, during an ignition-on phase. As soon as the user then leaves the vehicle and control unit 12 would normally be put to sleep, the described small part of control unit 12 remains awake. This part then carries out the update.

For this, control unit 12 is divided into several power domains 36, 38 in the example. This division allows the unnecessary chips and peripherals to be switched off. Additionally, a chip is used which recognizes different power modes, for example, integrated switching circuit Tegra T30 from the company Nvidia. This chip is clocked to a low frequency and unnecessary peripherals such as the described GPU, a SATA interface and a PCIe can be switched off. An update application, that is, a special operating software for park phase P, can be executed on the T30 processor, which either installs the update data which are locally stored or downloads update data from the internet into the internal memory. When the update is complete, power controller 24 is awakened, and control unit 12 goes fully to sleep.

The Internet connection can take place, for example, via the phone module or also a WLAN module. The update itself can also take place from an SD card to internal memory or from an additional internal memory to the internal memory for operating software 60. The maximum update time is limited by timer t_update_max.

Overall, the example shows how a system update for the control unit can be realized by employing the invention during a motor vehicle's low-power state.

1-13. (canceled)

14. A method for operating a control unit of a motor vehicle during a parking phase in which an ignition of the motor vehicle is switched off to disable devices of the motor vehicle, the method comprising:
receiving, by the control unit, an ignition-off signal for initiating the parking phase in the motor vehicle;
switching off at least one electronic component of the control unit after receiving the ignition-off signal;
operating, in the control unit during the parking phase, a processor core and a memory storage unit, in which is stored operating software provided for the operation of the control unit when the ignition is on, to carry out an update of the operating software via the processor core based on update data;
switching off, via an integrated circuit of a System-on-a-Chip, peripherals of the processor core and a memory controller of the memory storage unit not needed for the update as a function of the ignition-off signal;
activating a power controller of the control unit to stop the update, wherein the power controller is configured to control the energy usage of the control unit and switch off the processor core and the memory storage unit,
wherein the control unit has device electronics which comprise a circuit board on which are arranged electronic components necessary for the operation of the control unit,
wherein the device electronics are divided into a first power domain and a second power domain,
wherein each of the first and second power domains is linked by a respective electrical supply line via the power controller to a supply connection of the control unit,
wherein the processor core and the memory storage unit are assigned to the first power domain and the at least one electronic component is assigned to the second power domain, and
wherein upon receiving the ignition-off signal, the second power domain is electrically isolated from the supply connection via the power controller and the first power domain continues to be supplied with voltage.

15. The method of claim 1, wherein operating, in the control unit during the parking phase, the processor core and the memory storage unit further comprises:
operating the processor core and the memory storage using power supplied by a battery of the motor vehicle.

16. The method of claim 1, wherein the processor core and the memory controller of the memory storage unit are implemented via the integrated circuit having a variable clock rate and the clock rate is reduced as a function of the ignition off signal.

17. The method of claim 1, wherein when the ignition is on preceding the parking phase, at least one part of the update data is received over a transmission connection from outside the motor vehicle or from a portable device attached to the control unit and is stored in the memory storage unit.

18. The method of claim 1, wherein at least one part of the update data is read out from a portable storage medium connected to the control unit during the parking phase.

19. The method of claim 1, wherein at least one part of the update data is received from the Internet via a mobile wireless connection and/or a wireless local area network connection during the parking phase.

20. The method of claim 1, wherein a maximum provided time for the update is predetermined by a timer value stored in the control unit and an abort signal for terminating the update is created by a timer in the control unit as a function of the timer value.

21. The method of claim 1, wherein the processor core and the memory storage unit are not operated during the parking phase unless an update command is entered by a user of the motor vehicle into a control panel of the motor vehicle when the ignition is on before the parking phase.

22. The method of claim 1, wherein the control unit is an infotainment system or an instrument cluster.
